(19) United States
(12) Patent Application Publication
(10) Pub. No.: US 2018/0072878 A1
(43) Pub. Date: Mar. 15, 2018

(54) CHEMICALLY RESISTANT AND TOUGH CYCLIC OLEFIN COPOLYMER COMPOUNDS

(71) Applicant: Apple Inc., Cupertino, CA (US)

(72) Inventors: Yannan Duan, Westlake, OH (US); Roger W. Avakian, Solon, OH (US)

(21) Appl. No.: 15/565,328

(22) PCT Filed: Apr. 8, 2016
(86) PCT No.: PCT/US2016/026749

§ 371 Date: Oct. 9, 2017

Related U.S. Application Data
(60) Provisional application No. 62/146,036, filed on Apr. 10, 2015.
(60) Provisional application No. 62/209,332, filed on Aug. 24, 2015.

(51) Int. Cl. C08L 23/08

(52) U.S. Cl. CPC C08L 23/0823; C08L 2201/08; C08L 2205/05; C08L 2205/03; C08L 2205/025

(57) ABSTRACT

Cyclic olefin copolymer (COC) has its impact toughness and its resistance to UV absorbers and fatty acid derivatives enhanced to commercially acceptable levels by the addition of an impact modifying polymer selected from the group consisting of styrenic block copolymers and olefinic block copolymers and combinations thereof; and a linear or branched polyolefin, respectively.

### CROSS-REFERENCE

This application claims the benefit of the filing date under 35 U.S.C. § 119 to U.S. provisional patent application Ser. No. 62/146,036 filed Apr. 10, 2015 and entitled “Chemically Resistant and Tough Cyclic Olefin Copolymer Compounds,” and to U.S. provisional patent application Ser. No. 62/209,332 filed Aug. 24, 2015 and entitled “Chemically Resistant and Tough Cyclic Olefin Copolymer Compounds,” the disclosures of which are incorporated by reference in their entireties for all purposes.

### FIELD

The disclosure relates generally to polymers having chemical resistance and impact toughness to cyclic olefin copolymer. More particularly, various embodiments related to combinations of cyclic olefin copolymers with impact modifying polymers and polyolefins.

### BACKGROUND

Cyclic olefin copolymer (COC) is an amorphous, transparent copolymer based on polymerization of a combination of cyclic olefins and linear olefins. COC has high transparency, low water absorption, variable heat deflection temperature up to 170° C. and good resistance to acids and alkalis.

But COC also is known to have poor resistance to certain other chemicals with considerable chemical reactivity. Often, one common consumer product, sunscreen lotions which contain ultraviolet absorbers and fatty acid derivatives, serves as a litmus test of chemical resistance for polymers to be used in consumer products. The lack of chemical resistance of COC to sunscreen lotions hinders its use in consumer products. The ultraviolet absorbers and fatty acid derivatives in sunscreen make that lotion, when contact with a polymer compound, relentless in reactivity with COC.

Also COC is not tough enough to be suitable for metal replacement in many consumer products. COC needs impact strength.

As replacement of metal with polymers is considered for many consumer products from automobile parts to handheld electronic devices, COC has not been chosen because of its lack of chemical resistance and lack of toughness.

### SUMMARY

What the art needs is a chemically resistant, tough COC to become a candidate for metal replacement in consumer products.

It has been found, unexpectedly, that a combination of two other polymer types can provide both chemical resistance and impact toughness, particularly in balance, to be suitable for any consumer product as a metal replacement initiative.

One aspect of the disclosure is directed to a cyclic olefin copolymer compound comprising (a) cyclic olefin copolymer; (b) an impact modifying polymer selected from the group consisting of styrenic block copolymers and olefinic block copolymers and combinations thereof; and (c) a linear polyolefin, wherein the linear polyolefin resists chemical attack against the cyclic olefin copolymer by ultraviolet light absorbers.

Another aspect of the disclosure is directed to a cyclic olefin copolymer compound comprising (a) cyclic olefin copolymer; (b) an impact modifying polymer selected from the group consisting of styrenic block copolymers and olefinic block copolymers and combinations thereof; and (c) a branched polyolefin, wherein the branched polyolefin resists chemical attack against the cyclic olefin copolymer by ultraviolet light absorbers.

Another aspect of the disclosure is directed to any polymeric article made from either cyclic olefin copolymer compound identified above.

Embodiments of the disclosure explain the establishment of chemical resistance and impact strength in COC-based polymer compounds.

### DETAILED DESCRIPTION

It should be understood that the following descriptions are not intended to limit the embodiments to any particular embodiment. To the contrary, it is intended to cover alternatives, modifications, and equivalents as can be included within the spirit and scope of the described embodiments as defined by the appended claims.

Embodiments of this disclosure are directed to a cyclic olefin copolymer compound comprising (a) cyclic olefin copolymer; (b) an impact modifying polymer selected from the group consisting of styrenic block copolymers and olefinic block copolymers and combinations thereof; and (c) a polyolefins, including linear polyolefins and branched polyolefins, which resist chemical attack against the cyclic olefin copolymer by ultraviolet light absorbers. These cyclic olefin copolymer compounds may further comprise one or more optional additives.

### Cyclic Olefin Copolymer (COC)

Cyclic olefin copolymer (COC) can refer to copolymers of cyclic olefin monomers, such as norbornene or tetracyclododecene, with ethene or other alkenes. For example, in some embodiments, the COC may be an alkylene-tetracyclododecene copolymer, such as ethylene-tetracyclododecene copolymer or propylene-tetracyclododecene copolymer. In other embodiments, the COC may be an alkylene-norbornene copolymer, such as ethylene-norbornene copolymer or propylene-norbornene copolymer.

In some instances, the COC is ethylene-norbornene copolymer which has a CAS No. of 26007-43-2. Ethylene-norbornene copolymer may have the following structure:

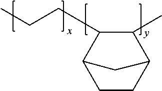

wherein X ranges from about 40 wt. % to about 20 wt. %, such as from about 25 wt. % to about 18 wt. % and wherein Y ranges from about 60 wt. % to about 80 wt. % and such as from about 75 wt. % to about 82 wt. %. In some embodiments, X may range from about 40 wt. % to about 20 wt. %, such as from about 25 wt. % to about 18 wt. %. In other embodiments, X may be at least about 18 wt. % of the COC. In other embodiments, X may be at least about 20 wt. % of the COC. In other embodiments, X may be less than about 40 wt. % of the COC. In other embodiments, X may be less than about 25 wt. % of the COC. In some embodiments, Y may range from about 60 wt. % to about 80 wt. % and such as from about 75 wt. % to about 82 wt. %. In other embodiments, Y may be at least about 60 wt. % of the COC. In other embodiments, Y may be at least about 75 wt. % of the COC. In other embodiments, Y may be less than about 82 wt. % of the COC. In other embodiments, Y may be less than about 80 wt. % of the COC.

Any COC is a candidate for use in the disclosure to have its chemical resistance and impact toughness enhanced.

COC should have a weight average molecular weight (Mw) ranging from about 40,000 to about 130,000, such as from about 93,000 to about 125,000.

In some embodiments, COC can have a Mw of at least about 40,000. In other embodiments, COC can have a Mw of at least about 93,000. In yet other embodiments, COC can have a Mw of less than about 130,000. In still other embodiments, COC can have Mw of less than about 125,000.

COC can have a heat deflection temperature ranging from about 30° C. to about 170° C., such as from about 75° C. to about 170° C. at 0.45 MPa (66 psi load).

In some embodiments, COC can have a heat deflection temperature of at least about 30° C. In other embodiments, COC can have a heat deflection temperature of at least about 75° C. In yet other embodiments, COC can have a heat deflection temperature of less than about 170° C. In still other embodiments, COC can have a heat deflection temperature of less than about about 170°. In various embodiments, the head deflection temperatures can be measured at a pressure of about 0.45 MPa (66 psi load).

Commercially available COC is sold by TOPAS Advanced Polymers using the TOPAS® brand. Of the commercial grades available, TOPAS® 6017S-04 COC, an injection molding grade, and TOPAS® 6013S-04, a general purpose injection molding grade may be selected because they have heat deflection temperatures within the TOPAS product family. TOPAS® 6017S-04 COC has a Vicat softening temperature B50 (50° C./h 50N) is 178° C. as tested using the procedure of ISO 306. Also, its degree of light transmission is 91% as tested using the procedure of ISO 13468-2. Its tensile modulus (1 mm/min) is 3000 MPa as tested using the procedure of ISO 527-2/1A.

TOPAS® 6013S-04 COC has a Vicat softening temperature B50 (50° C./h 50N) of 137° C. as tested using the procedure of ISO 306. Also, its degree of light transmission is 91% as tested using the procedure of ISO 13468-2. Its tensile modulus (1 mm/min) is 2900 MPa as tested using the procedure of ISO 527-2/1A.

In some variations, the COC can be a polymer with low amounts of oligomers. The COC can volatilize or plasticize other polymers it may contact. In some variations, the COC is non-polar polymer such that the COC compound has very little adhesive attraction to polar polymer compounds.

### Impact Modifiers

A polymer can be blended with COC to enhance impact toughness. Any well-known polymer known for providing impact strength to a polymer such COC can be used.

In some variations, the polymer includes an styrenic block copolymer (SBC). SBCs are block copolymers with at least one hard block of styrene monomer and one soft block of olefin monomer. Of the SBCs commercially available, styrene-butadiene-styrene (SBS), styrene-ethylene-butylene-styrene (SEBS), and styrene-ethylene-propylene-styrene (SEPS) are the leading SBCs used. Kraton LLC sells many different grades and combinations of these SBCs. Without wishing to be limited to a particular mechanism or mode of action, the styrenic block copolymers (SBCs) can provide elastomeric properties to a non-elastomeric polymer resin.

In some embodiments, the SBC may be selected from styrene-butadiene-styrene (SBS), styrene-ethylene-butylene-styrene (SEBS), styrene-ethylene-propylene-styrene (SEPS), styrene-isobutylene-styrene (SIBS), and combinations thereof. In some embodiments, the SBC is styrene-butadiene-styrene (SBS). In some embodiments, the SBC is styrene-ethylene-butylene-styrene (SEBS). In some embodiments, the SBC is styrene-ethylene-propylene-styrene (SEPS). In some embodiments, the SBC is styrene-isobutylene-styrene (SIBS).

In some variations, the impact modifier is an olefin block copolymer (OBC). OBCs are block copolymers with at least one hard block of polyethylene and one soft block of α-olefin ethylene copolymer. Dow Chemical sells many different grades and combinations of these OBCs. Without wishing to be limited to a particular mechanism or mode of action, OBCs may also provide elastomeric properties to a non-elastomeric polymer resin.

### Chemical Resistance Polymer

Polyolefins can provide chemical resistance against sunscreen lotion without unduly affecting the basic properties of COC. Further, the polyolefin can provide chemical resistance without unduly affecting the enhanced toughness provided by the impact modifier.

Any polyolefin can be used as a chemical resister to UV absorbers in sunscreen lotion. What is surprising is that the COC itself is olefinic but includes a linear polyolefins to provide the chemical resistance.

In some embodiments, the polyolefin is a polyalkylene. Non-limiting examples of suitable polyolefins include both polyethylenes (such as high density polyethylene (HDPE) and linear low density polyethylenes (LLDPE)) and linear and branched polypropylenes. These olefins can be acquired commercially from a large number of suppliers in a variety of grades and combinations.

### Optional Additives

The compound of the present disclosure can include conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (elsevier.com), can select from many different types of additives for inclusion into the compounds of the present disclosure.

Non-limiting examples of optional additives include adhesion promoters; biocides; antibacterials; fungicides; mildewcides; anti-fogging agents; anti-static agents; bonding, blowing agents; foaming agents; dispersants; fillers; extenders; fire retardants; flame retardants; flow modifiers; smoke suppressants; impact modifiers; initiators; lubricants; micas; pigments, colorants and dyes; plasticizers; processing aids; release agents; silanes, titanates and zirconates; slip agents; anti-blocking agents; stabilizers; stearates; ultraviolet light absorbers; viscosity regulators; waxes; and combinations of them.

In some embodiments, the optional additive is titanate comprising titanium dioxide. In some embodiments, the optional additive is a polyhedral oligomeric silsesquioxane (POSS), such as trisilanol-isobutyl POSS® or octaisobutyl POSS®. In some embodiments, the optional additive is a highly branched polyester dendrimer. In some embodiments, the optional additive is an antioxidant chosen from a phenolic primary antioxidant (such as Irganox™ 1010) or a phosphite antioxidant (such as Songnox™ 1680).

In some embodiments, the optional additives are melt-mix additives, which may not chemically react with the other cyclic copolymer compound constituents. When added, these optional additive may be solid ingredient additives to a melted copolymer compound.

Table 1 shows ranges of ingredients in polymeric articles containing thermally conductive, electrically insulative additives, all expressed in weight percent (wt. %) of the entire compound. The compound can comprise, consist essentially of, or consist of these ingredients. Any number between the ends of the ranges is also contemplated as an end of a range, such that all possible combinations are contemplated within the possibilities of Table 1 as candidate compounds for use in this disclosure.

TABLE 1

| | Broad | Intermediate | Narrow |
|---|---|---|---|
| COC | 40-75 | 49-67 | 48-57 |
| SBC or OBC Impact | 10-30 | 15-25 | 23-26 |
| Modifier | | | |
| Olefin Chemical Resistance | 15-30 | 18-26 | 20-26 |
| Polymer | | | |
| Optional Additives | 0-7 | 0-5 | 0-5 |

In some variations, the cyclic olefin copolymer compound disclosed herein may have a notched Izod measurement ranging between about 10.4 ft·lb/in to about 13.4 ft·lb/in (between about 718 J/m and about 556 J/m), such as between about 10.4 ft·lb/in to about 11 ft·lb/in, between about 11 ft·lb/in to about 12 ft·lb/in, or between about 12 ft·lb/in to about 13 ft·lb/in. In some embodiments, the cyclic olefin copolymer compound may have a notched Izod measurement of at least about 10.4 ft·lb/in (556 J/m). In other embodiments, the cyclic olefin copolymer compound may have a notched Izod measurement of less than about 13.4 ft·lb/in (718 J/m).

In other variations, the cyclic olefin copolymer compounds disclosed herein may have a tensile strength ranging between about 2940 psi and about 3710 psi, such as between about 2940 psi and about 3000 psi, between about 3000 psi and about 3100 psi, between about 3100 psi and about 3200 psi, between about 3200 psi and about 3300 psi, between about 3300 psi and about 3400 psi, between about 3400 psi and about 3500 psi, between about 3500 psi and about 3600 psi, and between about 3600 psi and about 3700 psi. In some embodiments, the cyclic olefin copolymer compound may have a tensile strength of at least about 2940 psi. In some embodiments, the cyclic olefin copolymer compound may have a tensile strength of less than about 3710 psi.

In other variations, the cyclic olefin copolymer compounds disclosed herein may have an elongation percentage ranging between about 36% to about 96%, such as between about 36% and about 40%, between about 40% and about 45%, between about 45% and about 50%, between about 50% and about 55%, between about 55% and about 60%, between about 60% and about 65%, between about 65% and about 70%, between about 70% and about 75%, between about 75% and about 80%, between about 80% and about 85%, between about 85% and about 90%, or between about 90% and about 95%. In some embodiments, the cyclic olefin copolymer compound may have an elongation percentage of at least 36%. In some embodiments, the cyclic olefin copolymer compound may have an elongation percentage of less than about 96%.

In other variations, the cyclic olefin copolymer compounds disclosed herein may have a tensile modulus ranging between about 113 ksi and about 166 ksi, such as between about 113 ksi and about 115 ksi, between about 115 ksi and about 120 ksi, between about 120 ksi and about 125 ksi, between about 125 ksi and about 130 ksi, between about 130 ksi and about 135 ksi, between about 135 ksi and about 140 ksi, between about 140 ksi and about 145 ksi, between about 145 ksi and about 150 ksi, between about 150 ksi and about 155 ksi, between about 155 ksi and about 160 ksi, or between about 160 ksi and about 165 ksi. In some embodiments, the cyclic olefin copolymer compound may have a tensile modulus of at least about 113 ksi. In some embodiments, the cyclic olefin copolymer compound may have a tensile modulus of less than about 165 ksi.

In other variations, the cyclic olefin copolymer compounds disclosed herein may have a flex strength ranging between about 3905 psi and about 5967 psi, such as between about 3905 psi and about 4000 psi, between about 4000 psi and about 4500 psi, between about 4500 psi and about 5000 psi, between about 5000 psi and about 5500 psi, or between about 5500 psi and about 5900 psi. In some embodiments, the cyclic olefin copolymer compound may have a flex strength of at least about 3905 psi. In some embodiments, the cyclic olefin copolymer compound may have a flex strength of less than about 5900 psi.

In other variations, the cyclic olefin copolymer compounds disclosed herein may have a flex modulus ranging between about 106 ksi and about 167 ksi, such as between about 106 ksi and about 110 ksi, as between about 110 ksi and about 120 ksi, as between about 120 ksi and about 130 ksi, as between about 130 ksi and about 140 ksi, as between about 140 ksi and about 150 ksi, as between about 150 ksi and about 160 ksi, or as between about 160 ksi and about 167 ksi. In some embodiments, the cyclic olefin copolymer compound may have a flex modulus of at least about 106 ksi. In some embodiments, the cyclic olefin copolymer compound may have a flex modulus of less than about 167 ksi.

### Processing

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), such as from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. In some embodiments, the mixing speeds may be at least about 60 rpm. In other embodiments, the mixing speeds may be less than about 1000 rpm. Also, the output from the mixer may be chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present disclosure.

If COC polymer compounds can be formulated to be both tough and impact resistant, then compounds of the present disclosure can be made into any extruded, molded, calendered, thermoformed, or 3D-printed article. Candidate end uses for such thermoplastic articles are listed in summary fashion below.

Appliances: Refrigerators, freezers, washers, dryers, toasters, blenders, vacuum cleaners, coffee makers, and mixers;

Building and Construction: Fences, decks and rails, floors, floor covering, pipes and fittings, siding, trim, windows, doors, molding, and wall coverings;

Consumer Goods: Power hand tools, rakes, shovels, lawn mowers, shoes, boots, golf clubs, fishing poles, and watercraft;

Electrical/Electronic Devices: Printers, computers, business equipment, LCD projectors, mobile phones and other handheld electronic devices, connectors, chip trays, circuit breakers, and plugs;

Healthcare: Wheelchairs, beds, testing equipment, analyzers, labware, ostomy, IV sets, wound care, drug delivery, inhalers, and packaging;

Industrial Products: Containers, bottles, drums, material handling, gears, bearings, gaskets and seals, valves, wind turbines, and safety equipment;

Consumer Packaging: Food and beverage, cosmetic, detergents and cleaners, personal care, pharmaceutical and wellness containers;

Transportation: Automotive aftermarket parts, bumpers, window seals, instrument panels, consoles, under hood electrical, and engine covers; and

Wire and Cable: Cars and trucks, airplanes, aerospace, construction, military, telecommunication, utility power, alternative energy, and electronics.

The copolymer compounds and embodiments as described herein can be included in various electronic devices. Such electronic devices can be any electronic devices known in the art. For example, the device can be a telephone, such as a mobile phone, and a land-line phone, or any communication device, such as a smart phone, including, for example an iPhone®, and an electronic email sending/receiving device. The alloys can be used in electric interconnects in a display, such as a digital display, a TV monitor, an electronic-book reader, a portable web-browser (e.g., iPad®), watch (e.g., AppleWatch), or computer monitor. Devices can also be entertainment devices, including a portable DVD player, conventional DVD player, Blue-Ray disk player, video game console, music player, such as a portable music player (e.g., iPod®), etc. Devices include control devices, such as those that control the streaming of images, videos, sounds (e.g., Apple TV®), or a remote control for a separate electronic device. The device can be a part of a computer or its accessories, laptop keyboard, laptop track pad, desktop keyboard, mouse, and speaker.

### EXAMPLES

### Comparative Examples A-K and Examples 1-22

Five series of experiments have been performed.

The First Series, Comparative Examples A-E showed COC formulations containing only impact modifier and pigments could not survive the Sunscreen Exposure Test identified below. All of Comparative Examples A-E showed stress cracking when undergoing the Sunscreen Exposure Test.

The Second Series, Comparative Examples F-K and Examples 1-3 showed the chemical resistance of COC under stress to sunscreen lotions can be significantly improved by blending with different polyolefins and different amounts of polyolefins. Some of the Examples showed very high notched Izod impact strength, close to 500 J/m. Most importantly, the distinctions between the successful Examples 1-3 and the unsuccessful Examples F-K demonstrate the unpredictability of how the addition of polyolefins counteracts the aggressiveness of sunscreen upon COC.

The Third Series, Examples 4-8 showed that formulations can be constructed to balance well both high notched Izod impact strength and sunscreen resistance of modified COC under the strain of the Sunscreen Exposure Test.

The Fourth Series, Examples 9-18 showed how the successful formulations of the Second and Third Series can have the flowability of COC blends improved by use of flow enhancers and selection of resin grades with different melt flow indices.

The Fifth Series, Examples 19-22 showed how use of linear and branched polypropylenes could also yield acceptable embodiments of the disclosure.

### Test Methods

Tensile Test, Rigid ASTM D-638

Flexural Properties ASTM D-790

IZOD Impact (notched) ASTM D-256

Dielectric constant and dissipation factor, ASTM D150

Sunscreen Exposure Test, explained below

Xenon Arc Weathering, ASTM D-4459 with insulated black panel to monitor the temperature.

### Sunscreen Exposure Test

The purpose of the test is to assess chemical resistance of COC formulations to sunscreen lotions while under strain.

Sample Preparation: The formulations are molded into ASTM D-638 Type I Tensile Bars and then fixed into a constant radius jig to induce 2.0% strain.

Sunscreen Lotion tested: Identified in the Tables 5-8

Test Procedures:

Apply 1 ml of Lotion on the neck region (or extensometer region) of the Tensile Bar specimens and spread the Lotion to cover at least 1 cm² area.

Gently wipe off any excess amount of Lotion using a clean, dry cloth but at least leave a layer of Lotion on surface of the Tensile Bar specimen.

Repeat application of Lotion every 2 hrs for the first 8 hours and four times a day at 2 hour intervals for four days thereafter.

Leave Tensile Bar specimens exposed to Lotion at room temperature (about 23° C.) for 5 days.

Wipe Tensile Bar specimens with a clean, dry cloth (no additional cleaning agents).

Examine specimens for any crazing/cracking/breakage.

### Formulations and Test Results

Table 2 shows the list of ingredients. Table 3 shows the extrusion conditions. Table 4 shows the molding conditions. Tables 5-10 show the recipes and the test results.

TABLE 2

| Brand Name | Ingredient and Purpose | Commercial Source |
|---|---|---|
| SCLAIR ® 2907 | HDPE (high density | NOVA Chemicals |
| | polyethylene) | |
| Novapol ® GF- | LLDPE (linear low density | NOVA Chemicals |
| 0218 | polyethylene) | |
| Pro-Fax ® 6331 | PP (linear polypropylene) | Basell Polyolefins |
| Pro-Fax ® | PP (linear polypropylene) | Basell Polyolefins |
| HP403G | | |
| Inspire ® 114 | PP (branched | Braskem (formerly |
| | polypropylene) | Dow) |
| SibStar ® 102T | SIBS(Styrene Iso- Butylene | Kaneka |
| | Styrene, styrenic block | |
| | copolymer) | |
| Topas ® 6017S | COC (cyclic olefin | TOPAS Advanced |
| | copolymer) | Polymers, Inc. |
| Topas ® 6013S | COC (cyclic olefin | TOPAS Advanced |
| | copolymer) | Polymers, Inc. |
| Kraton ® G1651 | SEBS polymer | Kraton Performance |
| | | Polymers, Inc. |
| TIONA ® RCL 4 | TiO₂ | Cristal Global |
| NOVAPOL ® PI- | LLDPE (linear low density | NOVA Chemicals |
| 2024-A | polyethylene) | |
| SO1450 | Trisilanol-isobutyl POSS ® | Hybrid Plastics |
| MS0825 | OctaIsobutyl POSS ® | Hybrid Plastics |
| Boltron ™ H20 | Highly branched polyester | Perstorp |
| | dendrimer | |
| Irganox ™ 1010 | Phenolic Primary | BASF |
| | Antioxidant | |
| Songnox ™ 1680 | Phosphite Antioxidant | Songwon |

TABLE 3
Extruder Conditions
All Comparative Examples and Examples

| | |
|---|---|
| Extruder Type | Prism 16 mm TSE (40 L/D) screw |
| | extruder |
| Order of Addition | All ingredients mixed together and fed |
| | into the extruder hopper. |
| Zone 1 | 280° C. |
| Zone 2 | 280° C. |
| Zone 3 | 280° C. |
| Zone 4 | 280° C. |
| Zone 5 | 280° C. |
| Zone 6 | 280° C. |
| Zone 7 | 280° C. |
| Zone 8 | 280° C. |
| Zone 9 | 280° C. |
| Die | 280° C. |
| Revolution speed | 300 rpm |

TABLE 4
Molding Conditions
All Comparative Examples and Examples
Nissei 88 molding machine
Drying Conditions before Molding:

| | |
|---|---|
| Temperature (° C.) | 80° C. |
| Time (h) | 16 hrs for First-Third, Fifth Series; |
| | 4 hrs for Fourth Series |

Temperatures:

| | |
|---|---|
| Nozzle (° C.) | 260 |
| Zone 1 (° C.) | 254 |
| Zone 2 (° C.) | 249 |
| Zone 3 (° C.) | 243 |
| Mold (° C.) | 145 for First-Third, Fifth Series; |
| | 62 for Fourth Series |
| Oil Temp (° C.) | 43 |

Speeds:

| | |
|---|---|
| Screw RPM (%) | 60 |
| % Shot - Inj Vel Stg 1 | 50 |
| % Shot - Inj Vel Stg 2 | 40 |
| % Shot - Inj Vel Stg 3 | 30 |
| % Shot - Inj Vel Stg 4 | 20 |
| % Shot - Inj Vel Stg 5 | 10 |

Pressures:

| | |
|---|---|
| Hold Stg 1 (mPa) - | 6 |
| Time(sec) | |
| Hold Stg 2 (mPa) - | No stg 2 |
| Time(sec) | |

Timers:

| | |
|---|---|
| Injection Hold (sec) | 7 |
| Cooling Time (sec) | 20 |

Operation Settings:

| | |
|---|---|
| Shot Size (mm) | 44 |
| Cushion (mm) | 2.5 for First-Third Series; |
| | 3.2 for Fourth Series |

TABLE 5
First Series

| Example | Comp. A | Comp. B | Comp. C | Comp. D | Comp. E |
|---|---|---|---|---|---|
| Kraton ® G1651 SEBS | 10.00 | | 10.00 | 20.00 | 15.00 |
| Topas ® 6013S COC | 88.00 | | | | |
| Topas ® 6017S COC | | 98.00 | 88.00 | 78.00 | 83.00 |
| TIONA ® RCL 4 TiO₂ | 2.00 | 2.00 | 2.00 | 2.00 | 2.00 |
| Total (%) | 100.0 | 100.0 | 100.0 | 100.0 | 100.0 |
| Sunscreen Exposure Test | — | Broke | Broke | Broke | Broke |
| Result (Three sunscreen | | | | | |
| lotions for First-series: | | | | | |
| Hawaiian Tropic ® SPF | | | | | |
| 50, Coppertone ® SPF 30, | | | | | |
| and Banana Boat ® SPF | | | | | |
| 30) | | | | | |
| Notched Izod (ft · lb/in) | — | 0.22 | 1.12 | 3.29 | 2.67 |
| Stdev (ft · lb/in) | — | 0.01 | 0.09 | 0.17 | 0.10 |
| Notched Izod (J/m) | — | 11.40 | 60.10 | 176.00 | 143.00 |
| Stdev (J/m) | — | 0.25 | 4.85 | 8.82 | 5.32 |
| Tensile strength (psi) | — | 7511 | 7296.3 | 5641.4 | 6360.60 |
| Stdev (psi) | — | 662.5 | 140.7 | 49.4 | 37.70 |
| Elongation % | — | 2.054 | 5.67 | 15.539 | 7.44 |
| Stdev (%) | — | 0.243 | 0.649 | 1.765 | 2.32 |
| Tensile modulus (ksi) | — | 424.00 | 348.36 | 280.76 | 318.48 |
| Stdev (ksi) | — | 3.31 | 3.92 | 3.03 | 2.30 |
| Flex strength (psi) | — | 12988.6 | 13189.2 | 10094.9 | 11976.3 |
| Stdev (psi) | — | 384.0 | 279.2 | 292.8 | 202.50 |
| Flex modulus (ksi) | — | 440.00 | 365.00 | 285.00 | 337.00 |
| Stdev (ksi) | — | 5.00 | 10.00 | 8.00 | 5.00 |
| Xenon Arc Weathering | CIE 94 Delta E | | | | |
| (Hrs. according to Comp. | | | | | |
| Example) | | | | | |
| A&E: 145; B-D: 142 | 0.10 | 0.66 | 0.57 | 0.75 | 0.20 |
| A&E: 315; B-D: 311 | 0.20 | 0.67 | 0.51 | 0.55 | 1.16 |
| A&E: 482; B-D: 479 | 0.38 | 1.52 | 1.06 | 0.84 | 2.38 |
| A&E: 650; B-D: 642 | 0.89 | 3.28 | 2.46 | 2.04 | 3.88 |
| A&E: 818; B-D: 813 | 1.78 | 4.96 | 4.29 | 3.48 | 5.43 |
| A&E: 983; B-D: 983 | 1.85 | 5.74 | 5.35 | 4.75 | 6.74 |
| B-D: 1150 | | 5.65 | 5.21 | 4.97 | |

TABLE 6
Second Series

| | Example | | | | | | | | |
|---|---|---|---|---|---|---|---|---|---|
| | Comp. F | 1 | Comp. G | 2 | Comp. H | 3 | Comp. I | Comp. J | Comp. K |
| Topas ® 6017S COC | 60.00 | 54.00 | 60.00 | 54.00 | 60.00 | 54.00 | 40.00 | | 80.00 |
| Topas ® 6013S COC | | | | | | | | 80.00 | |
| Kraton ® G1651 SEBS | | 20.00 | | 20.00 | | 20.00 | | 20.00 | |
| SCLAIR ® 2907 HDPE | 40.00 | 26.00 | | | | | 60.00 | | |
| Novapol ® GF-0218 | | | 40.00 | 26.00 | | | | | |
| LLDPE | | | | | | | | | |
| Pro-Fax ® 6331 PP | | | | | 40.00 | 26.00 | | | |
| SibStar ® 102T SIBS | | | | | | | | | 20.00 |
| Total (%) | 100.0 | 100.0 | 100.0 | 100.0 | 100.0 | 100.0 | 100.0 | 100.0 | 100.0 |
| Sunscreen Exposure Test | OK | OK | OK | OK | Broken | OK | OK | Broken | Broken |
| Result (One sunscreen for | | | | | | | | | |
| Second Series: Banana | | | | | | | | | |
| Boat ® SPF 30) | | | | | | | | | |
| Notched Izod (ft. lb/in) | 0.34 | 4.98 | 0.56 | 9.27 | 0.26 | 1.21 | 0.54 | 8.14 | 0.41 |
| Stdev (ft. lb/in) | 0.01 | 0.71 | 0.24 | 0.35 | 0.07 | 0.07 | 0.4 | 0.8 | 0.05 |
| Notched Izod (J/m) | 17.9 | 266 | 30.1 | 495.5 | 13.7 | 64.9 | 28.9 | 435 | 21.9 |
| Stdev (J/m) | 0.74 | 38.2 | 12.7 | 18.6 | 4.07 | 3.57 | 21.5 | 43 | 2.54 |
| Tensile strength (psi) | 5485.7 | 4755 | 5038.2 | 4083.5 | 5430.2 | 4687.1 | 4046.2 | 5309.9 | 6290.8 |
| Stdev (psi) | 73.9 | 32.4 | 68.7 | 14.1 | 628.7 | 25 | 404.1 | 99.7 | 49.4 |
| Elongation % | 3.392 | 22.891 | 9.25 | 27.909 | 2.776 | 6.354 | 6.409 | 13.721 | 3.434 |
| Stdev (%) | 0.227 | 5.022 | 1.339 | 4.389 | 0.21 | 1.727 | 0.973 | 7.967 | 0.351 |
| Tensile modulus (ksi) | 314.17 | 225.2 | 232.2 | 184.9 | 325.7 | 242.2 | 242.7 | 269.7 | 308.4 |
| stdev | 1.7 | 1.3 | 2.4 | 1.9 | 20.2 | 3.3 | 9.4 | 3.8 | 10.5 |
| Flex strength (psi) | 10457.8 | 8380.2 | 8810.9 | 7274.4 | 11086 | 8881.5 | 7770.3 | 10107.6 | 11607.5 |
| Stdev (psi) | 86.7 | 63.9 | 88.5 | 73.3 | 1361.5 | 120.3 | 642.1 | 385.8 | 111.9 |
| Flex modulus (ksi) | 336 | 238 | 246 | 202 | 332 | 263 | 265 | 295 | 325 |
| Stdev (ksi) | 3 | 4 | 2 | 3 | 43 | 8 | 11 | 8 | 2 |
| Xenon Arc Weathering | CIE 94 Delta E | | | | | | | | |
| (Hrs.) | | | | | | | | | |
| 218 | 0.72 | 1.53 | 2.5 | 2.72 | 1.71 | 1.61 | 0.48 | 1.48 | 1.62 |
| 330 | 1.43 | 1.86 | 2.57 | 2.48 | 1.19 | 1.09 | 1.89 | 1.52 | 4.37 |
| 386 | 1.8 | 2.24 | 2.42 | 2.28 | 0.61 | 1.09 | 2.36 | 1.45 | 1.45 |
| 551 | 3.35 | 3.19 | 1.38 | 1.63 | 0.76 | 1.16 | 3.99 | 1.46 | 1.66 |

TABLE 7
Third Series

| Example | 4 | 5 | 6 | 7 | 8 |
|---|---|---|---|---|---|
| Kraton ® G1651 SEBS | 20.00 | 20.00 | 23.00 | 23.00 | 23.00 |
| Topas ® 6013S COC | | | | 35.00 | 24.00 |
| Topas ® 6017S COC | 53.00 | 52.00 | 49.00 | 14.000 | 25.00 |
| TIONA ® RCL 4 TiO₂ | 1.00 | 2.00 | 2.00 | 2.00 | 2.00 |
| Novapol ® GF-0218 | 26.00 | 26.00 | 26.00 | 26.00 | 26.00 |
| LLDPE | | | | | |
| Total (%) | 100.0 | 100.0 | 100.0 | 100.0 | 100.0 |
| Sunscreen Exposure Test | OK | OK | OK | OK | OK |
| Result (One sunscreen for | | | | | |
| Third Series: Banana | | | | | |
| Boat ® SPE 30) | | | | | |
| Notched Izod (ft · lb/in) | 9.74 | 9.82 | 10.8 | 12.1 | 11.6 |
| Stdev (ft · lb/in) | 0.38 | 0.44 | 0.52 | 0.51 | 0.48 |
| Notched Izod (J/m) | 521 | 525 | 578 | 649 | 622 |
| Stdev (J/m) | 19.1 | 23.7 | 27.2 | 26.6 | 25.5 |
| Tensile strength (psi) | 3959.9 | 3958.4 | 3663.3 | 3490.1 | 3592.4 |
| Stdev (psi) | 110.5 | 61.9 | 46.9 | 40.1 | 26 |
| Elongation % | 26.61 | 30.676 | 46.85 | 63.606 | 54.271 |
| Stdev (%) | 9.679 | 3.451 | 6.729 | 6.839 | 5.818 |
| Tensile modulus (ksi) | 176.61 | 177.95 | 162.48 | 161.88 | 163.82 |
| Stdev (ksi) | 4.77 | 2.46 | 2.18 | 1.71 | 1.49 |
| Flex strength (psi) | 6735.5 | 6581.9 | 5959.2 | 5739.1 | 5929.5 |
| Stdev (psi) | 183.3 | 181.8 | 121.9 | 57.1 | 55.7 |
| Flex modulus (ksi) | 179 | 173 | 156 | 153 | 157 |
| Stdev (ksi) | 8 | 5 | 4 | 3 | 2 |
| Xenon Arc Weathering | CIE 94 Delta E | | | | |
| (Hrs.) | | | | | |
| 164 | 1.4 | 1.1 | 0.96 | 0.84 | 0.97 |
| 333 | 1.5 | 0.9 | 0.87 | 0.76 | 0.9 |

TABLE 8
Fourth Series

| | Example | | | | | | | | | |
|---|---|---|---|---|---|---|---|---|---|---|
| | 9 | 10 | 11 | 12 | 13 | 14 | 15 | 16 | 17 | 18 |
| Kraton G1651 SEBS | 20.00 | 23.000 | 23.00 | 23.00 | 23.00 | 23.00 | 23.00 | 23.00 | 23.00 | 23.00 |
| Topas 6013S COC | 52.00 | 49.00 | 35.00 | 34.00 | 32.00 | 34.00 | 30.00 | 34.00 | 30.00 | 35.00 |
| Topas 6017S COC | | | | 14.00 | 14.00 | 14.00 | 14.00 | 14.00 | 14.00 | 14.00 |
| TIONA ® RCL 4 TiO₂ | 2.00 | 2.00 | 2.00 | 2.00 | 2.00 | 2.00 | 2.00 | 2.00 | 2.00 | 2.00 |
| Novapol ® GF-0218 LLDPE | 26.00 | 26.00 | 40.00 | 26.00 | 26.00 | 26.00 | 26.00 | 26.00 | 26.00 | |
| Boltron ™ H20 Polyester | | | | 1.00 | 3.00 | | | | | |
| Dendrimer | | | | | | | | | | |
| SO1450 Trisilanol- | | | | | | 1.00 | 5.00 | | | |
| Isobutyl POSS ® | | | | | | | | | | |
| MS0825 - Octa-Isobutyl | | | | | | | | 1.00 | 5.00 | |
| POSS ® | | | | | | | | | | |
| NOVAPOL ® PI-2024 | | | | | | | | | | 26.00 |
| LLDPE | | | | | | | | | | |
| Total (%) | 100.0 | 100.0 | 100.0 | 100.0 | 100.0 | 100.0 | 100.0 | 100.0 | 100.0 | 100.0 |
| Sunscreen Exposure Test | OK | OK | OK | OK | OK | OK | OK | OK | OK | OK |
| Result (One sunscreen for | | | | | | | | | | |
| Fourth-Series: Banana | | | | | | | | | | |
| Boat ® SPF 30) | | | | | | | | | | |
| Notched Izod (ft. lb/in) | 13.0 | 13.4 | 12.5 | 12.8 | 12.7 | 12.9 | 12.3 | 13.1 | 13.0 | 10.4 |
| Stdev (ft. lb/in) | 0.2 | 0.27 | 0.24 | 0.16 | 0.24 | 0.39 | 0.21 | 0.26 | 0.23 | 0.35 |
| Notched Izod (J/m) | 693 | 718 | 666 | 684 | 679 | 688 | 660 | 697 | 692 | 556 |
| Stdev (J/m) | 10.6 | 14.3 | 12.2 | 9.31 | 11.9 | 21.1 | 11.2 | 13.7 | 12.9 | 18.6 |
| Tensile strength (psi) | 3710.7 | 3470.2 | 2935.9 | 3602.3 | 3504.5 | 3518.1 | 3185.8 | 3574.3 | 3249.6 | 3520.9 |
| Stdev (psi) | 57.5 | 27.7 | 26.4 | 57.5 | 68.3 | 23.1 | 39.1 | 58.2 | 19.4 | 54.3 |
| Elongation % | 37.211 | 66.074 | 96.426 | 43.905 | 44.997 | 42.336 | 57.626 | 56.897 | 55.426 | 36.376 |
| Stdev (%) | 15.136 | 10.442 | 4.85 | 7.152 | 10.354 | 8.047 | 14.412 | 9.681 | 17.092 | 2.982 |
| Tensile modulus (ksi) | 166.37 | 154.81 | 112.74 | 159.27 | 151.66 | 156.92 | 139.2 | 129.76 | 144.5 | 164.25 |
| Stdev (ksi) | 2.46 | 1.46 | 1.67 | 1.46 | 1.14 | 1.33 | 3.06 | 58.969 | 1.65 | 2.51 |
| Flex strength (psi) | 5967.2 | 5623.7 | 3904.3 | 5574.2 | 5554.9 | 5556.5 | 4892.7 | 5409.9 | 5001.8 | 5619 |
| Stdev (psi) | 27.1 | 74.9 | 21.5 | 58.3 | 112.9 | 25.8 | 38.4 | 38.8 | 21.8 | 41.4 |
| Flex modulus (ksi) | 167 | 156 | 106 | 152 | 149 | 151 | 134 | 148 | 141 | 158 |
| Stdev (ksi) | 2 | 2 | 1 | 1 | 3 | 2 | 1 | 1 | 1 | 1 |
| Xenon Arc Weathering | CIE 94 Delta E | | | | | | | | | |
| (Hrs.) | | | | | | | | | | |
| 168 | 0.90 | 0.85 | 0.87 | 1.73 | 1.39 | 0.52 | 0.60 | 0.80 | 1.18 | 0.92 |

TABLE 9
Fifth Series

| Example | 19 | 20 | 21 | 22 |
|---|---|---|---|---|
| Kraton ® G1651 SEBS | 22.98 | 22.98 | 23 | 23 |
| Topas ® 6013S COC | 34.91 | 34.91 | 35 | 35 |
| Topas ® 6017S COC | 13.97 | 13.97 | 14 | 14 |
| Inspire ® 114 PP (0.5 melt | 25.94 | | 26 | |
| flow rate¹) | | | | |
| Pro-Fax ® HP403G (1.5 | | 25.94 | | 26 |
| melt flow rate) | | | | |
| (Irganox 1010) | 0.1 | 0.1 | 0 | 0 |
| (Add ingredient here | 0.1 | 0.1 | 0 | 0 |
| Songnox 1680) | | | | |
| TIONA ® RCL 4 TiO₂ | 2 | 2 | 2 | 2 |
| Total (%) | 100.0 | 100.0 | 100.0 | 100.0 |
| Sunscreen Exposure Test | OK | OK | OK | OK |
| Result (Banana Boat ® | | | | |
| SPF 30) | | | | |
| Notched Izod (ft · lb/in) | 1.45 | 1.3 | 4.55 | 2.58 |
| ASTM D256 | | | | |
| Stdev (ft · lb/in) | 0.2 | 0.2 | 0.41 | 0.11 |
| Notched Izod (J/m) | 77.40 | 69.39 | | |
| Stdev (J/m) | 10.7 | 10.7 | | |
| Tensile strength (psi) | 2290 | 4038 | 4003 | 4173 |
| ASTM D-638 | | | | |
| Stdev (psi) | 45 | 29 | 65 | 17 |
| Elongation % ASTM D- | 29 | 25 | 39 | 29 |
| 638 | | | | |
| Stdev (%) | 10.2 | 11.4 | 4.9 | 2.5 |
| Tensile modulus (ksi) | 183.18 | 211.79 | 211.6 | 223.2 |
| ASTM D-638 | | | | |
| Stdev (ksi) | 2.3 | 1.8 | 3.0 | 0.1 |
| Flex strength (psi) | 6678 | 7547 | | |
| Stdev (psi) | 20.1 | 22.1 | | |
| Flex modulus (ksi) | 202.20 | 217.30 | | |
| Stdev (ksi) | 2.1 | 1.9 | | |
| Shore A Hardness ASTM | | | 72.4 | 73.8 |
| D-2240 Instant | | | | |
| Shore A Hardness ASTM | | | 67.9 | 69.3 |
| D-2240 15 second delay | | | | |
| Mean Brittle Failure | | | 240 | 257.3 |
| Energy (MBFE) (in · lb) | | | | |
| ASTM D-4226 | | | | |
| MBFE stdev | | | 3.6 | 3.3 |
| MBFE/thickness | | | 1.94 | 2.1 |
| (in · lb/mil) | | | | |
| Xenon Arc Weathering | CIE 94 Delta E | | | |
| (Hrs. according to Comp. | | | | |
| Example) ASTM D-2565 | | | | |
| t = 168 h | | | 0.77 | 0.87 |
| t = 333 h | | | 0.64 | 0.68 |
| t = 502 h | | | 0.48 | 0.54 |

¹g/10 min (230° C./2.16 kg)

TABLE 10

| | | | | | |
|---|---|---|---|---|---|
| Frequency (Hz) | 1 MHz | 10 MHz | 100 MHz | 500 MHz | 1 GHz |

Comp. Example E

| | | | | | |
|---|---|---|---|---|---|
| Dielectric | 2.37 | 2.38 | 2.37 | 2.37 | 2.36 |
| Constant | | | | | |
| Dissipation | 8.84 × | 3.62 × | 0.63 × | 0.10 × | 0.00 × |
| Factor | 10⁻³ | 10⁻³ | 10⁻³ | 10⁻³ | 10⁻³ |

Example 6

| | | | | | |
|---|---|---|---|---|---|
| Dielectric | 2.39 | 2.40 | 2.40 | 2.40 | 2.40 |
| Constant | | | | | |
| Dissipation | 2.09 × | 3.02 × | 2.70 × | 0.00 × | 0.13 × |
| Factor | 10⁻³ | 10⁻³ | 10⁻³ | 10⁻³ | 10⁻³ |

Comparative Examples B-E all failed because none had any chemical resistance polymer added. Comparative Example A is expected to also fail, if it had been tested. Also Comparative Example B, which had no impact modifier either, had a very poor Notched Izod value, compared with Comparative Examples C-E which did have impact modifier.

Comparative Examples F, G, H, and I contained no impact modifier but did contain polyolefin chemical resistance modifier. While the results were acceptable against chemical resistance, the Notched Izod impact results were totally unacceptable. To be acceptable, one must have at least about 53 Joules/meter toughness (1.0 ft·lb/in) in the Notched Izod test. Desirably, the toughness is at least 265 J/m (5 ft·lb/in.), such as at least 530 J/m (10 ft·lb/in.) and has been found in one Example to be as much as 649 J/m (12.1 ft·lb/in.).

Comparative Examples J and K contained no polyolefin chemical resistance modifier. While the Notched Izod impact results were acceptable, the breakage failures of the Sunscreen Exposure Test were totally unacceptable.

This Second Series of tests confirms that the well-balanced COC polymer compound uses all three polymers: COC, impact modifier such as SBC, and chemical resistance modifier such as linear PP or PE to solve the deficiencies of COC respecting toughness and chemical resistance to sunscreen.

However, what distinguishes Examples 1-3 from Comparative Examples A-K is the presence of both impact modifier and chemical resistance modifier. Acceptable chemical resistance is achieved whether the polyolefin is HDPE, LLDPE, or linear PP (Examples 1, 2 or 3, respectively).

The success of Examples 1-3 provided the basis for the Third and Fourth Series experiments which further refined embodiments of the disclosure. The Third Series explored the grades of COC to benefit from the disclosure, and some variation in impact modifier content. The Fourth Series continued that exploration along with consideration of flow modifiers. The test results indicated that the COC polymer compound can produce intricate, thin-walled parts by injection molding without defects by use of a variety of flow modifiers. We have observed improvement of surface visually of molded parts (⅛ inch ASTM bars). The surface tends to be smoother.

The Fifth Series experiments showed that use of either linear polypropylene or branched polypropylene as an Olefin Chemical Resistance Polymer resulted in acceptable chemical resistance and physical properties. It was also noted that the titanium dioxide for coloration also provided increased apparent hardness of the polymer compound when molded. Examples 19 and 20 differed from Examples 21 and 22 based on the use of minor amounts of anti-oxidants, further indicating to a person having ordinary skill in the art how properties of the desired polymer compound are affected by optional additives. Nonetheless, the chemical resistance and physical properties were acceptable with or without such antioxidants, regardless whether a linear or a branched polypropylene was used.

Xenon Arc Weathering data demonstrated that for the First Series, all formulations showed very low delta E under the Xenon Arc weathering test. The CIE 94 Delta E is less than 2 after 300 hours. For the Second Series, the CIE 94 delta E varies in the range of 1-5 after 300 hours depending on which olefin chemical resistance polymer is used. For the Third Series, the CIE 94 Delta E is less than 2 after 300 hours. For the Fourth Series, the CIE 94 Delta E is also less than 2 after 168 hours.

Table 10 shows a comparison for Dielectric Constant and Dissipation Factor between a formulation which had not Chemical Resistance Polymer (Comp. Ex. E) and which did (Example 6). The results showed that these formulations have low dielectric constant and low dissipation factor, which are key factors for many electronic applications. The addition of olefin chemical resistance polymer, SBC or OBC impact modifier or other additives did not alter the low dielectric constant and low dissipation factor up to 1 GHz. The dielectric constant of Topas® COC is around 2.35, which is typical of the values obtained with olefinic materials. It stays constant in the high frequency area up to 20 GHz.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A cyclic olefin copolymer compound, comprising:
(a) cyclic olefin copolymer;
(b) an impact modifying polymer selected from the group consisting of styrenic block copolymers and olefinic block copolymers and combinations thereof; and
(c) a linear polyolefin,
wherein the linear polyolefin resists chemical attack against the cyclic olefin copolymer by ultraviolet light absorbers and fatty acid derivatives.

2. A cyclic olefin copolymer compound, comprising:
(a) cyclic olefin copolymer;
(b) an impact modifying polymer selected from the group consisting of styrenic block copolymers and olefinic block copolymers and combinations thereof; and
(c) a branched polyolefin,
wherein the branched polyolefin resists chemical attack against the cyclic olefin copolymer by ultraviolet light absorbers and fatty acid derivatives.

3. The compound of claim 1 or claim 2, wherein the cyclic olefin copolymer (COC) is a copolymer of cyclic olefin monomers with alkenes.

4. The compound of claim 3, wherein the cyclic olefin copolymer is ethylene-norbornene copolymer which has a CAS No. of 26007-43-2.

5. The compound of claim 4, wherein the ethylene-norbornene copolymer has the following structure: 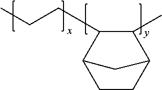
wherein X ranges from about 40 wt. % to about 20 wt. % and wherein Y ranges from about 60 wt. % to about 80 wt. %.

6. The compound of claim 4, wherein the ethylene-norbornene copolymer has the following structure: 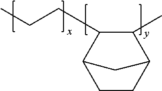
wherein X ranges from about 25 wt. % to about 18 wt. % and wherein Y ranges from about 75 wt. % to about 82 wt. %.

7. The compound of claim 4, wherein the cyclic olefin copolymer has a weight average molecular weight (Mw) ranging from about 40,000 to about 130,000, and a heat deflection temperature ranging from about 30° C. to about 170° C. at 0.45 MPa (66 psi load).

8. The compound of claim 1, wherein the impact modifying polymer is styrene-ethylene-butylene-styrene and wherein the linear polyolefin is selected from the group consisting of high density polyethylene, linear low density polyethylene, linear polypropylene, and combinations thereof.

9. The compound of claim 2, wherein the polyolefin is branched polypropylene.

10. The compound of any one of claims 1-9, wherein the support material further comprises one or more optional additives selected from the group consisting of adhesion promoters, biocides, antibacterials, fungicides, mildewcides, anti-fogging agents, anti-static agents, bonding agents, blowing agents, foaming agents, dispersants, fillers, extenders, fire retardants, flame retardants, smoke suppressants, impact modifiers, initiators, lubricants, micas, pigments, colorants, dyes, plasticizers, processing aids, release agents, silanes, titanates, zirconates, slip agents, anti-blocking agents, stabilizers, stearates, viscosity regulators, waxes, and combinations of them.

11. A polymer article comprising the compound of any one of claims 1-10.

12. The polymer article of claim 11, wherein the polymer article is in a shape resulting from any extruding, molding, calendering, thermoforming, or 3D-printing process.
